(19) United States
(12) Patent Application Publication
(10) Pub. No.: US 2013/0299608 A1
(43) Pub. Date: Nov. 14, 2013

(54) SHOWERHEAD WITH MULTI-DIMENSIONAL FLUID DISPENSERS

(71) Applicants: Anthony G. Spangler, Indianapolis, IN (US); Paul V. Patton, Indianapolis, IN (US); Garry Robin Marty, Fishers, IN (US); Brian Wayne Johnson, Muncie, IN (US)

(72) Inventors: Anthony G. Spangler, Indianapolis, IN (US); Paul V. Patton, Indianapolis, IN (US); Garry Robin Marty, Fishers, IN (US); Brian Wayne Johnson, Muncie, IN (US)

(73) Assignee: Masco Corporation of Indiana, Indianapolis, IN (US)

(21) Appl. No.: 13/876,321

(22) PCT Filed: Sep. 28, 2011
(86) PCT No.: PCT/US11/53699

§ 371 Date: Jul. 17, 2013

Related U.S. Application Data
(60) Provisional application No. 61/387,399, filed on Sep. 28, 2010.

(51) Int. Cl. B05B 1/16; A47K 3/28; B05B 1/30

(52) U.S. Cl. CPC B05B 1/16; B05B 1/30; A47K 3/28
USPC 239/444; 239/562; 239/525

(57) ABSTRACT

A showerhead assembly including a first fluid dispensing unit including a plurality of first fluidic devices, and a second fluid dispensing unit removably coupled to the first fluid dispensing unit and including a plurality of second fluidic devices. The first fluidic devices and the second fluidic devices each provide a multi-dimensional spray pattern.

### BACKGROUND AND SUMMARY OF THE INVENTION

The present invention relates generally to showerheads and, more particularly, to showerheads including multi-dimensional fluid dispensers.

Showerhead assemblies are known to dispense water through outlets, such as nozzles, in order to generate a spray of water within a bathing area. Some such showerhead assemblies include mechanisms for adjusting the spray of water dispensed from the outlets. It is also known to provide a showerhead assembly including a handshower, which may direct a spray of water separate from a base or fixed showerhead. The handshower may be removably mounted or docked to the fixed showerhead wherein water may be delivered to the bathing area through both the showerhead and the handshower. Such showerhead assemblies are illustrated, for example, in U.S. Pat. No. 7,360,723 to Lev, U.S. Pat. No. 7,665,676 to Lev, and U.S. Patent Application Publication No. 2009/0007330 to Genord et al.

According to an illustrative embodiment of the present disclosure, a showerhead assembly is provided including a plurality of multi-dimensional fluidic devices for providing multi-dimensional spray patterns. In one illustrative embodiment, the showerhead assembly includes a handshower removably coupled to a base showerhead. A plurality of two-dimensional (2D) fluidic devices are supported by the handshower and are configured to produce a fan of water within a plane by oscillating a water stream about a center axis. A plurality of three-dimensional (3D) fluidic devices are supported by the base showerhead and are configured to produce a plurality of fans of water within diverging planes, by oscillating a water stream within each of the planes about a respective center axis.

According to another illustrative embodiment of the present disclosure, a showerhead assembly includes a first fluid dispensing unit including a plurality of first fluidic devices, and a second fluid dispensing unit removably coupled to the first fluid dispensing unit and including a plurality of second fluidic devices. The first fluidic devices and the second fluidic devices each provide a multi-dimensional spray pattern.

According to a further illustrative embodiment of the present disclosure, a showerhead assembly includes a base, and a handshower removably coupled to the base. A plurality of two dimensional fluidic devices are supported by the handshower and are configured to produce a fan of water within a plane by oscillating water about a center axis. A flow control valve is configured to control the flow rate of water delivered to the two dimensional fluidic devices supported by the handshower.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of an illustrative showerhead assembly of the present disclosure, showing a handshower docked with a base showerhead;

FIG. 2 is a perspective view of the illustrative handshower assembly of FIG. 1, showing the handshower uncoupled from the base showerhead;

FIG. 3 is a cross-sectional view taken along line 3-3 of FIG. 1;

FIG. 4 is a cross-sectional view taken along line 4-4 of FIG. 1;

FIG. 5 is a front plan view of the illustrative showerhead assembly of FIG. 1;

FIGS. 6A and 6B are exploded perspective views of the base showerhead of FIG. 1;

FIG. 7 is a cross-sectional view of the base showerhead waterway, taken along line 7-7 of FIG. 5;

FIG. 8A is a detail view of the waterway of FIG. 7;

FIG. 8B is a further detail view of the waterway of FIG. 7;

FIG. 9 is a front exploded perspective view of the handshower of FIG. 1;

FIG. 10 is a partial rear exploded perspective view of the handshower of FIG. 1;

FIG. 11 is a cross-sectional view of the handshower waterway, taken along line 11-11 of FIG. 5;

FIG. 12 is a perspective view in partial schematic of the water dispensed by a two-dimensional fluidic device of the present disclosure;

FIG. 13A is a perspective view in partial schematic of the water dispensed by a three-dimensional fluidic device of the present disclosure;

FIG. 13B is a top plan view in partial schematic of the water dispensed by the three-dimensional fluidic device of FIG. 13A;

FIG. 13C is a side elevational view in partial schematic of the water dispensed by the three-dimensional fluidic device of FIG. 13A;

FIG. 14 is partial front perspective view of another illustrative showerhead;

FIG. 15 is a cross-sectional view of the showerhead of FIG. 14 taken along line 15-15;

FIG. 16 is a cross-sectional view of the showerhead of FIG. 15 taken along line 16-16;

FIG. 17 is an exploded perspective view of the showerhead of FIG. 14;

FIG. 18 is perspective view of an illustrative showerhead assembly, showing another docking arrangement between the handshower and the base showerhead;

FIG. 19 is a partial exploded perspective view of the illustrative handshower assembly of FIG. 18, showing the handshower uncoupled from the base showerhead and with internal waterway components of the handshower removed for clarity;

FIG. 20A is a cross-sectional view of the illustrative handshower assembly of FIG. 19, showing the handshower coupled to the base showerhead;

FIG. 20B is a cross-sectional view similar to FIG. 20A, showing the handshower partially uncoupled from the base showerhead;

FIG. 21A is a schematic representation of illustrative flux lines of a magnetic field of a disc magnet;

FIG. 21B is a schematic representation of illustrative flux lines of a magnetic field of a disc magnet received within a backing element;

FIG. 22 is a perspective view of an illustrative showerhead assembly including a flow control valve;

FIG. 23A is a partial cross-sectional view of the showerhead assembly of FIG. 22, showing the flow control valve in a low flow mode;

FIG. 23B is a partial cross-sectional view similar to FIG. 23A, showing the flow control valve in a high flow mode;

FIG. 24 is an exploded perspective view of the flow control valve of FIG. 22;

FIG. 25 is a front plan view of a further illustrative showerhead assembly of the present disclosure;

FIG. 26 is a front plan view of a further illustrative showerhead assembly of the present disclosure;

FIG. 27 is a front plan view of a further illustrative showerhead assembly of the present disclosure; and

FIG. 28 is a front plan view of a further illustrative showerhead assembly of the present disclosure.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

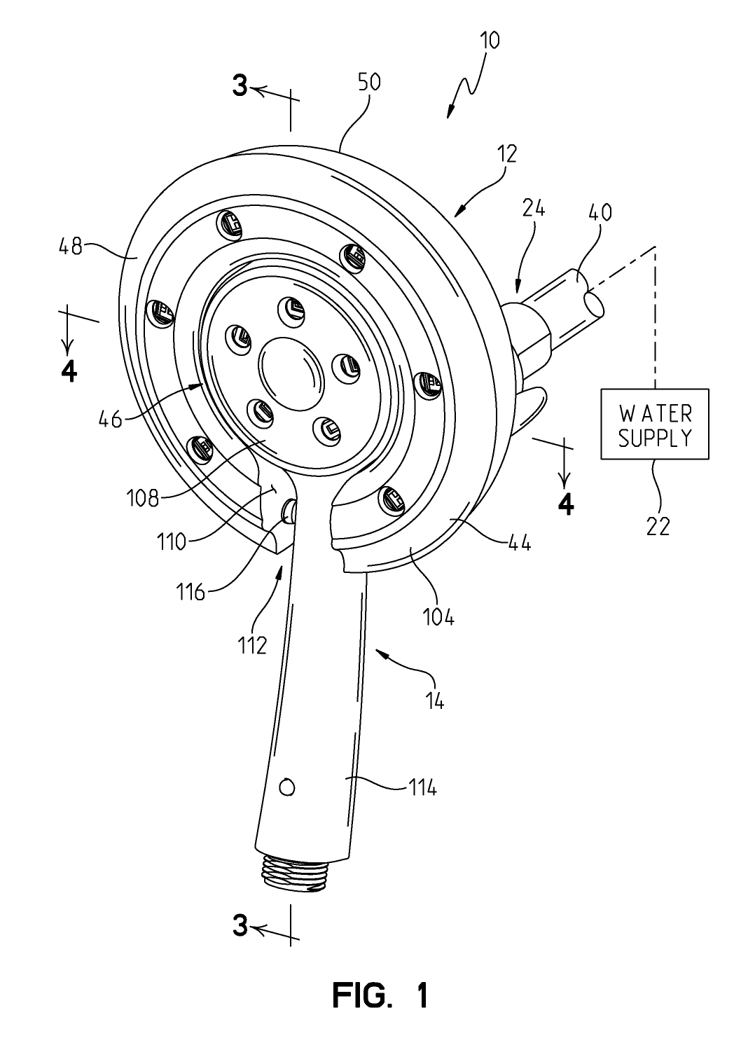

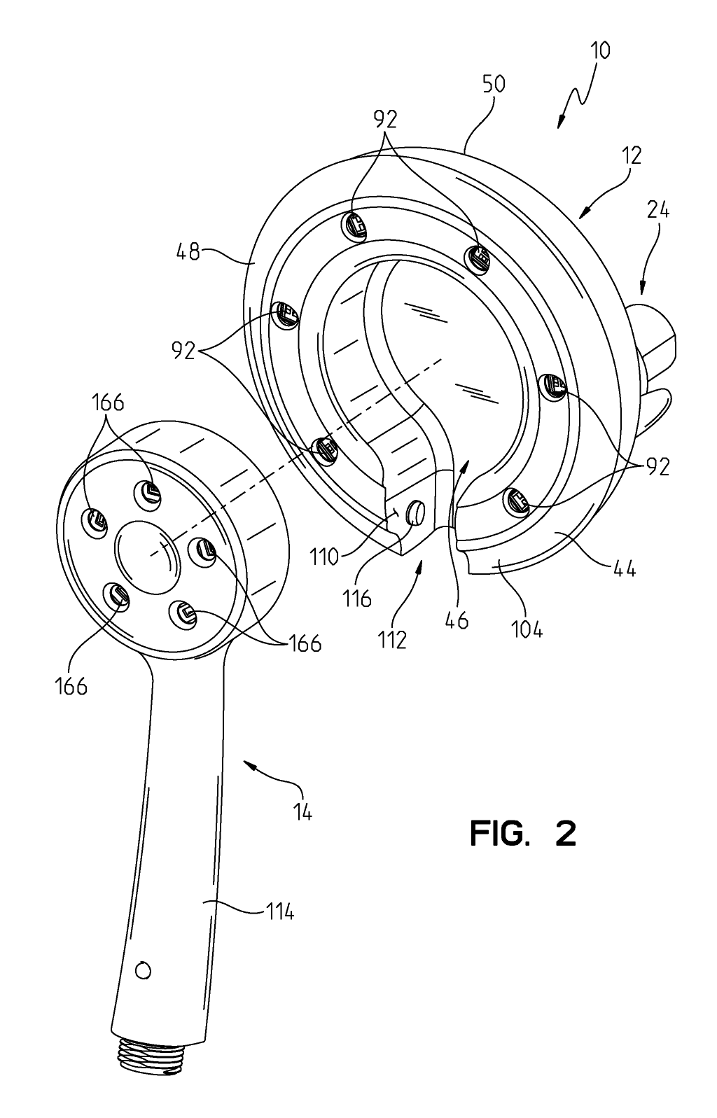

Referring initially to FIGS. 1 and 2, a showerhead assembly 10 illustratively includes a first fluid dispensing unit 12 and a second fluid dispensing unit 14 removably coupled to the first fluid dispensing unit 12. Illustratively, the first fluid dispensing unit 12 comprises a fixed or base showerhead configured to be supported from a shower wall (not shown) above a user (often referred to as an overhead shower). The second fluid dispensing unit 14 illustratively comprises a handheld wand or handshower. The handshower 14 removably couples or docks with the base showerhead 12. A water supply 22 provides water to the base showerhead 12 and the movable handshower 14.

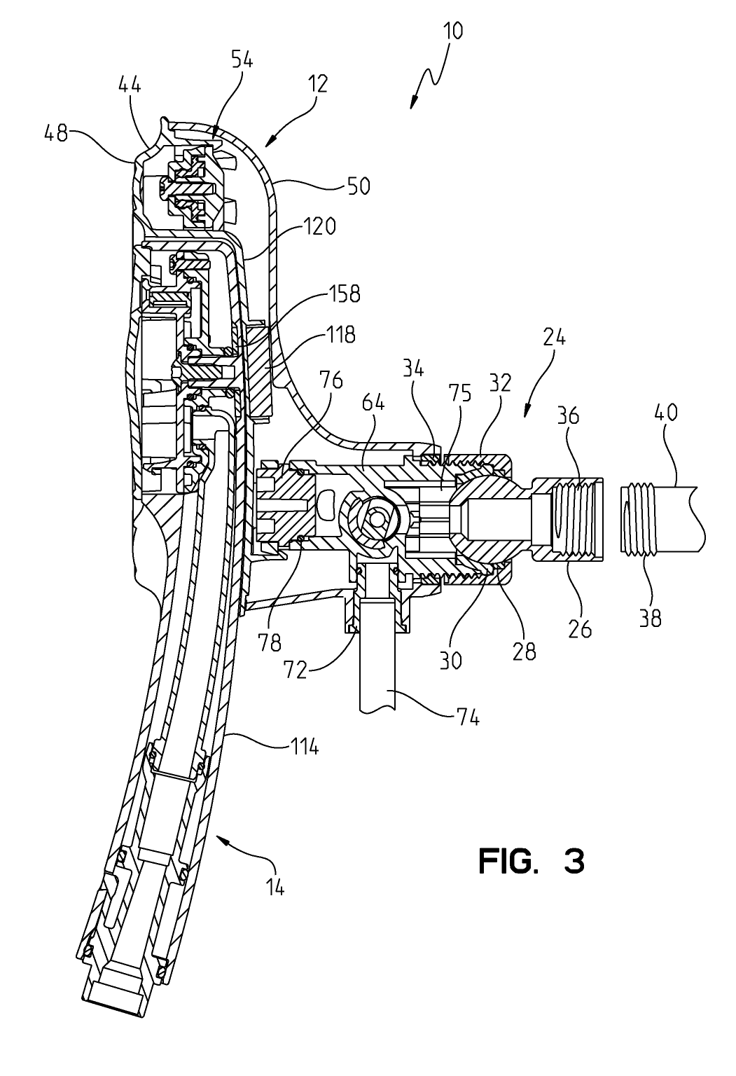

The water supply 22 is fluidly coupled to the showerhead assembly 10 through a fluid connector 24. With reference to FIGS. 3, 4, and 6B, the fluid connector 24 illustratively includes a shower ball 26 and a screw ring 28 received between a ball washer 30 and a ball connector 32. The shower ball 26 permits rotational movement of the showerhead 12 about orthogonal axes. Internal threads 36 in the shower ball 26 facilitate connection to external threads 38 of a pipe or riser 40 (FIGS. 1 and 3) supported by the shower wall (not shown). As further detailed herein, a flow restrictor may be provided to limit the flow rate of water from the water supply 22 into the showerhead assembly 10.

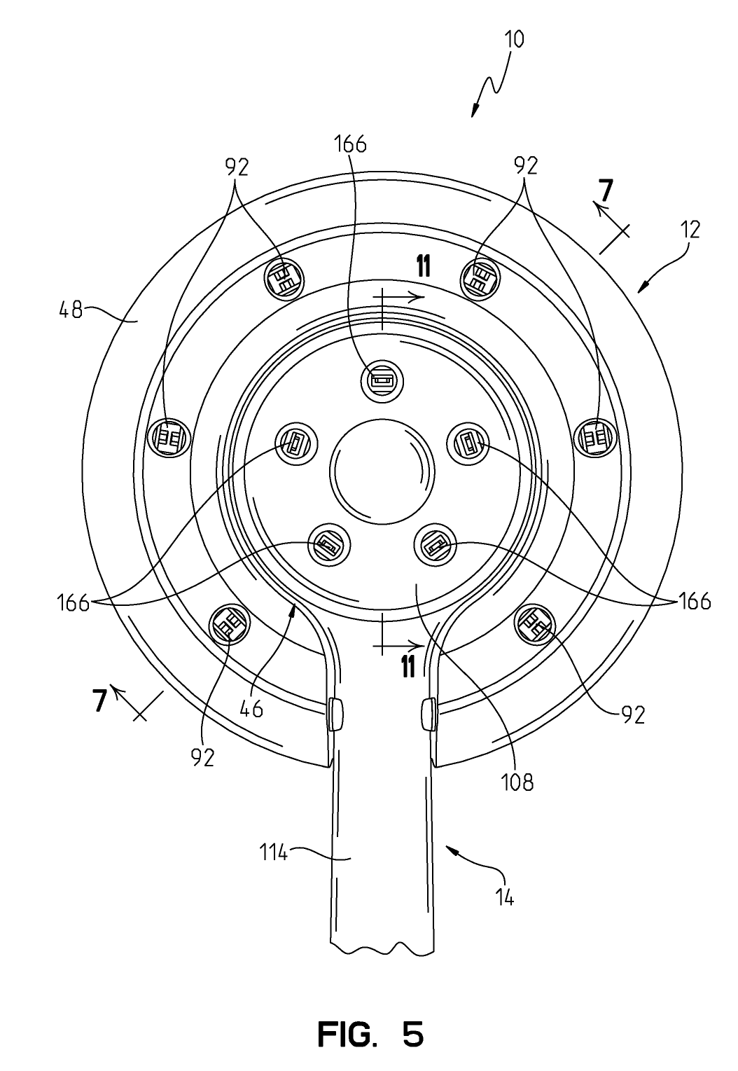

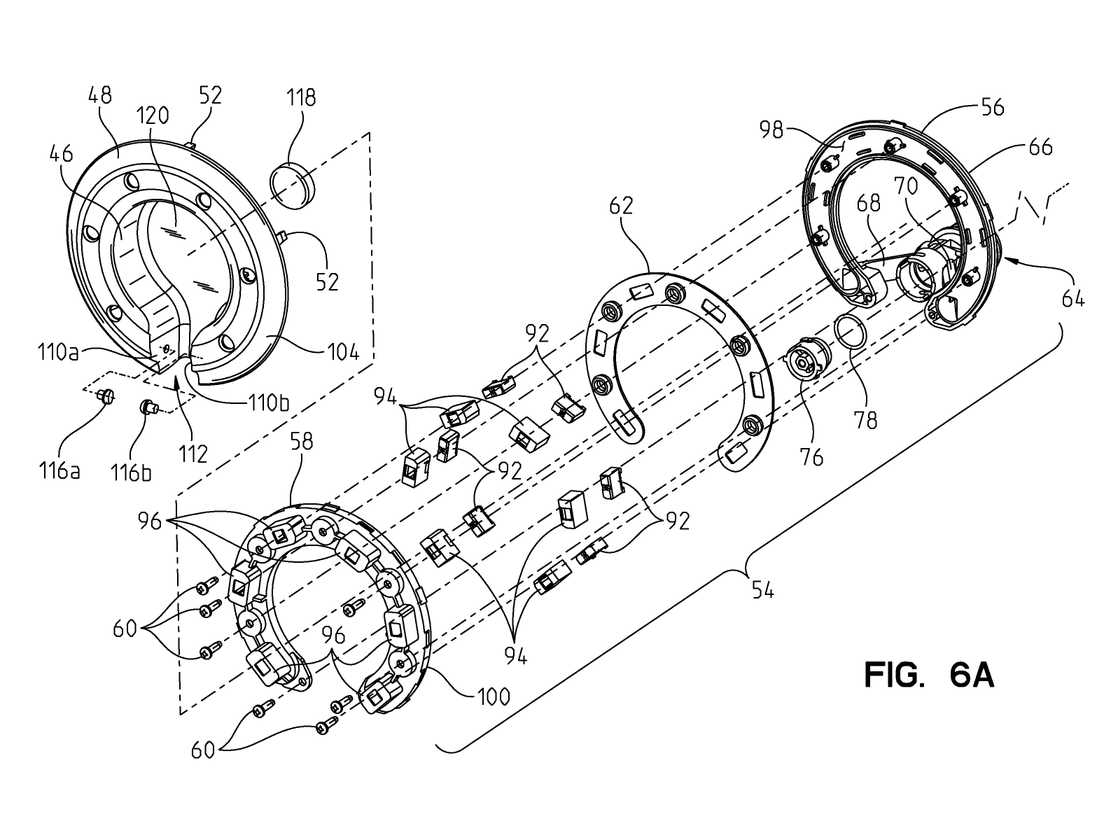

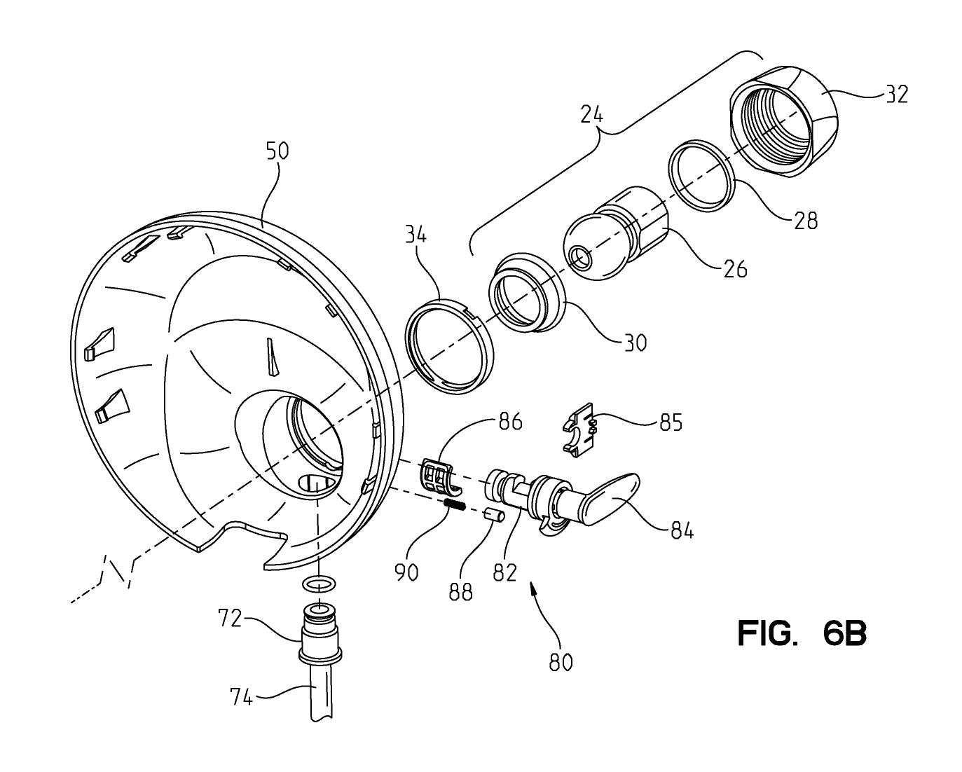

In the illustrative embodiment of FIGS. 1 and 2, the base showerhead 12 includes an arcuate housing 44 defining a ring with a center recess or opening 46 configured to removably receive the handshower 14. The housing 44 illustratively includes a front trim 48 coupled to a rear trim 50 by a plurality of resilient latch tabs 52 (FIG. 6A). An engine assembly 54 is received within the housing 44.

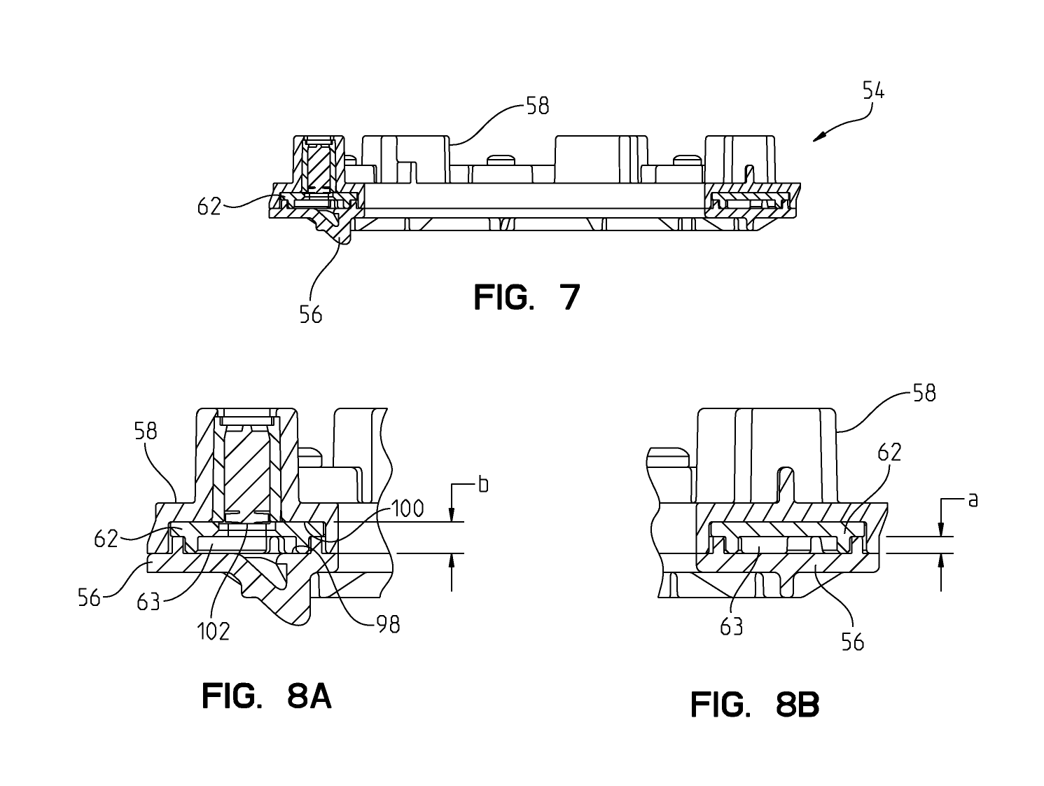

With reference to FIGS. 6A, 6, and 7, the engine assembly 54 illustratively includes a waterway 56 secured to a spray face 58 through a plurality of screws 60. A gasket 62 provides a seal between the waterway 56 and the spray face 58. A water chamber 63 is defined between the waterway 56 and the gasket 62 (FIG. 8A). In certain other embodiments, the waterway 56 and the spray face 58 may be coupled together through other means providing a seal therebetween, including through adhesives or hot plate welding, thereby eliminating the need for the screws 60 and gasket 62.

Referring to FIGS. 3 and 6A, the waterway 56 illustratively includes an inlet 64 fluidly coupled to an arcuate member 66 through a pair of tubular arms 68, 70. The inlet 64 supports the fluid connector 24. A nut 34 secures the rear trim 50 to the inlet 64. A tubular member 72 is supported by the waterway 56 and may be fluidly coupled to the handshower 14 through a flexible hose 74 (FIG. 3). A flow restrictor 75 may be supported proximate a rear end of the inlet 64 and is configured to limit the rate of water flow therethrough to no more than a predetermined value. In one illustrative embodiment, the flow restrictor 75 limits the water flow rate to no more than 2.5 gallons per minute (gpm). In another illustrative embodiment, the flow restrictor 75 limits flow rate to no more than 2.0 gallons per minute (gpm) in accordance with the WaterSense Specification for Showerheads as released by the U.S. Environmental Protection Agency on Mar. 4, 2010 (available at the website http://www.epa.gov/watersense/docs/showerheads_{—finalspec}508.pdf).

A plug 76 and an o-ring 78 may seal a front end of the inlet 64. The plug 76 may be secured to the inlet 64 using conventional couplers, such as resilient fingers, threads, or a bayonet coupling. Alternatively, the plug 76 may be sealing secured to the front end of the inlet 64 through means such as adhesives or hot plate welding, thereby eliminating the need for the o-ring 78.

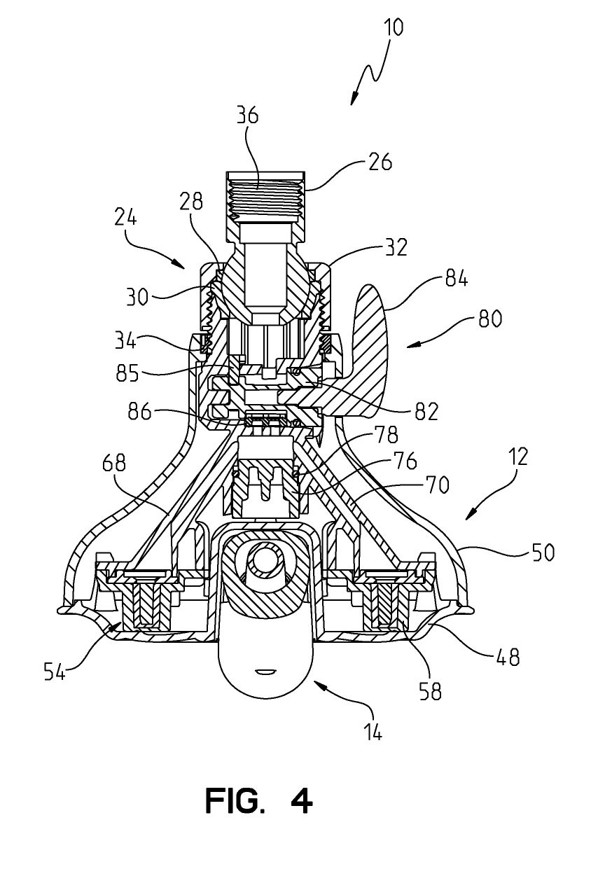

With reference to FIGS. 4 and 6B, a diverter valve 80 is supported by the waterway 56 and is configured to provide selective or combined water flow to either or both of the base showerhead 12 and the handshower 14. The diverter valve 80 illustratively includes a control member 82 coupled to a knob 84 for rotation therewith. The control member 82 is illustratively rotatably coupled to inlet 64 by a retaining clip 85. The control member 82 cooperates with a gasket 86 for selectively directing water to the tubular arms 68,70 (and spray face 58 of showerhead 12) and/or the tubular member 72 (and handshower 14). A detent 88 biased by a spring 90 provides for selective locking of the control member 82 in one of three positions, each position being offset by 45 degrees from an adjacent position. In a first position, water flow is directed by the diverter valve 80 to the spray face 58 of the showerhead 12. In a second position, water flow is directed to the tubular member 72 and the handshower 14. In a third position, water flow is directed to both the spray face 58 (of the showerhead 12) and the tubular member 72 (and the handshower 14 through hose 74).

A plurality of multi-dimensional fluid dispensers or fluidic devices 92 are supported by the spray face 58 and are in fluid communication with the water chamber 63 of the waterway 56. As further detailed herein, a multi-dimensional fluidic device is configured to produce a stream or jet of water moving in at least two dimensions. Each fluidic device 92 is illustratively received within a housing 94 which, in turn, is received within a projection or boss 96 formed in the spray face 58. Illustratively, the fluidic devices 92 are dimensioned to be press fit within the housings 94, and the housings 94 are dimensioned to be press fit within the bosses 96. The housings 94 may also be ultrasonically welded to the bosses 96.

With reference to FIGS. 7-8B, the water chamber 63 defined between the waterway 56 and the gasket 62 is configured to effectively minimize the volume of the chamber 63 in order to provide for improved responsiveness of the fluidic devices 92 upon water flow activation (i.e., “quick on” of all fluidic devices 92). The gasket 62 is retained between an outwardly facing surface or seat 98 of the waterway 56 and an inwardly facing surface or seat 100 of the spray face 58. Illustratively, the fluidic devices 92 are supported substantially outwardly from the spray face 58. As shown in the illustrative embodiment of FIG. 8A, inlets 102 of the fluidic devices 92 are supported substantially flush with the seat 100 of the spray face 58 (i.e., substantially within the same plane). The bosses 96 extend forwardly from the seat 100 to provide a substantially constant cross-sectional flow area between the gasket 62 and the seat 98 of waterway 56. In other words, large changes in volume of the water chamber 63 between fluidic devices 92 are eliminated. In the illustrative embodiment, the dimension “a” (FIG. 8B) between gasket 62 and seat 98 is approximately 0.080 inches in order to provide quick responsiveness of fluidic devices 92 upon water activation, while the dimension “b” (FIG. 8A) between inlet 102 of fluidic device 92 is approximately 0.120 inches in order to provide proper water flow to, and operation of, fluidic devices 92.

The front trim 48 includes an arcuate outer portion or ring 104 supported forwardly of the spray face 58. The front portion 48 and the engine assembly 54 cooperate to define the center recess 46 configured to receive an outlet portion or spray head housing 108 of the handshower 14. Opposing faces 110a, 110b define a lower slot 112 to receive a handle 114 of the handshower 14. A pair of opposing bumpers 116a, 116b, illustratively formed of an elastomer, may be used to help retain the handle 114 in proper position within the slot 112. In certain illustrative embodiments as further detailed herein, at least one magnet 118 may be supported by a rear wall 120 of the front trim 48 and is configured to releasably secure the handshower 14 to the base showerhead 12.

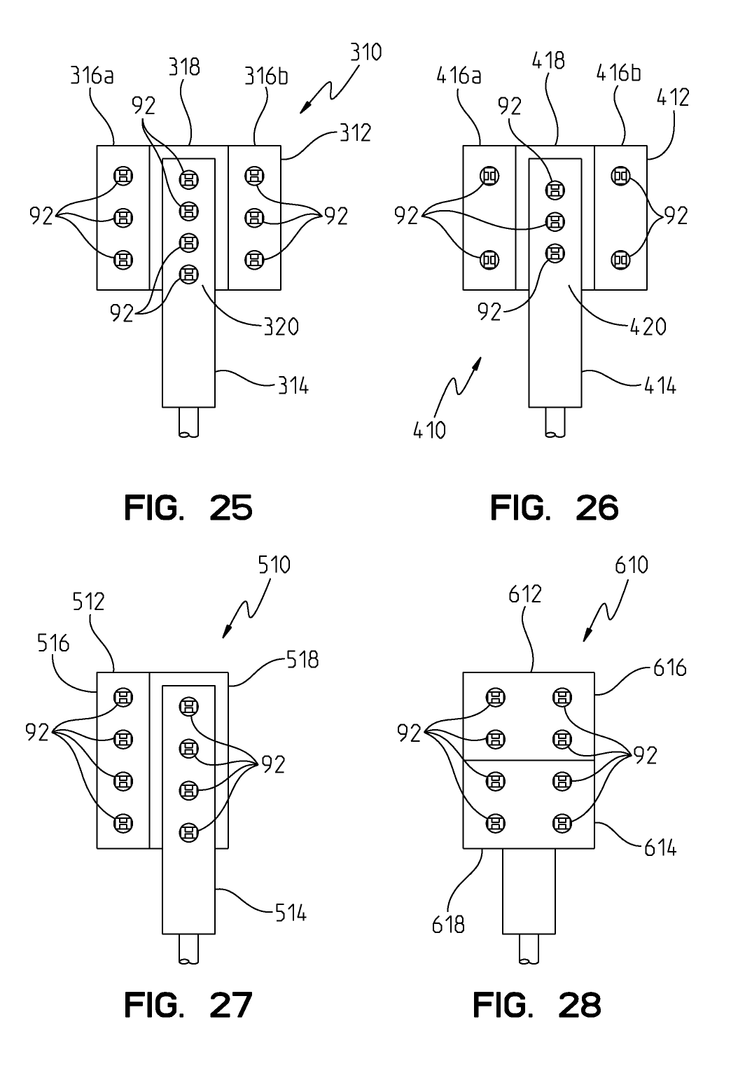

While the illustrative embodiment engine assembly 54 and front trim 48 are shown as defining a semi-circle with a lower slot 112, other configurations may be substituted therefor. For example, the engine assembly 54 and the front trim 48 may take the form of other polygonal shapes, such as rectangles and triangles. Additional configurations are detailed below in connection with FIGS. 25-28.

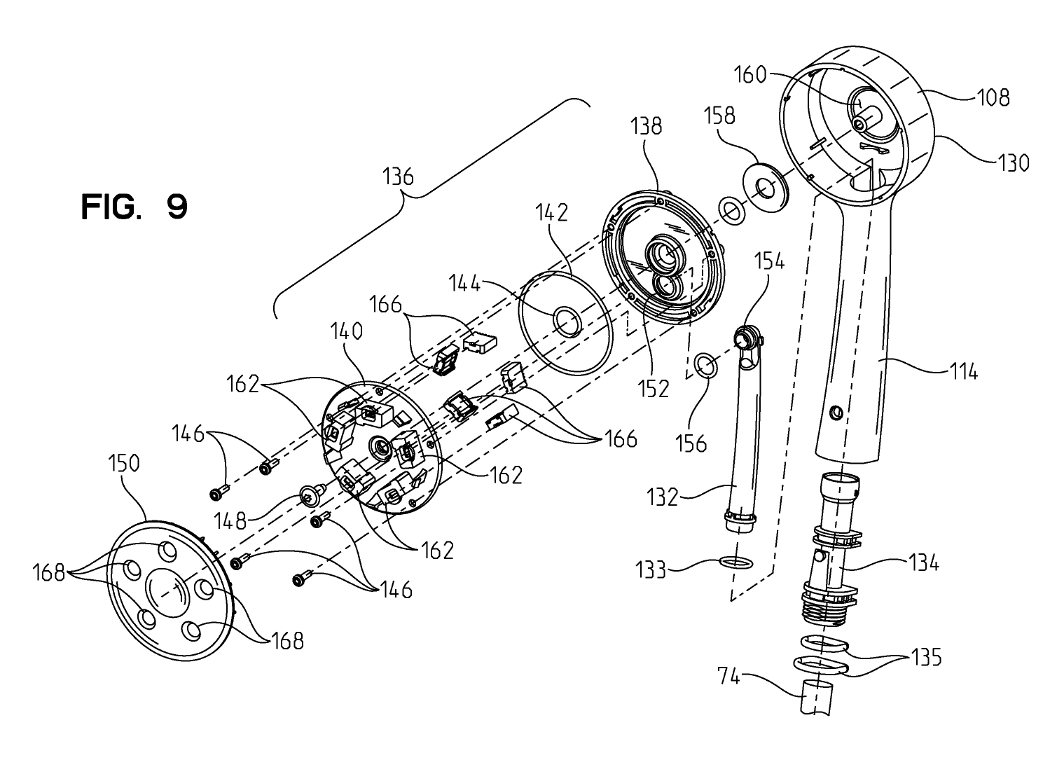

With reference to FIGS. 3, 9, 10, and 11, the handshower 14 illustratively includes a shell 130 defining the handle 114 and the spray head housing 108. A waterway 132 is received within the handle 114 and is fluidly coupled to a waterway adapter 134 with an o-ring 133 therebetween. The waterway adapter 134 is configured to fluidly couple to the flexible hose 74 extending to the inlet 64 of the showerhead 12. Sealing members 135 are positioned between adapter 134 and handle 114. A handshower engine 136 is received within the spray head housing 108 and is fluidly coupled to the waterway 132.

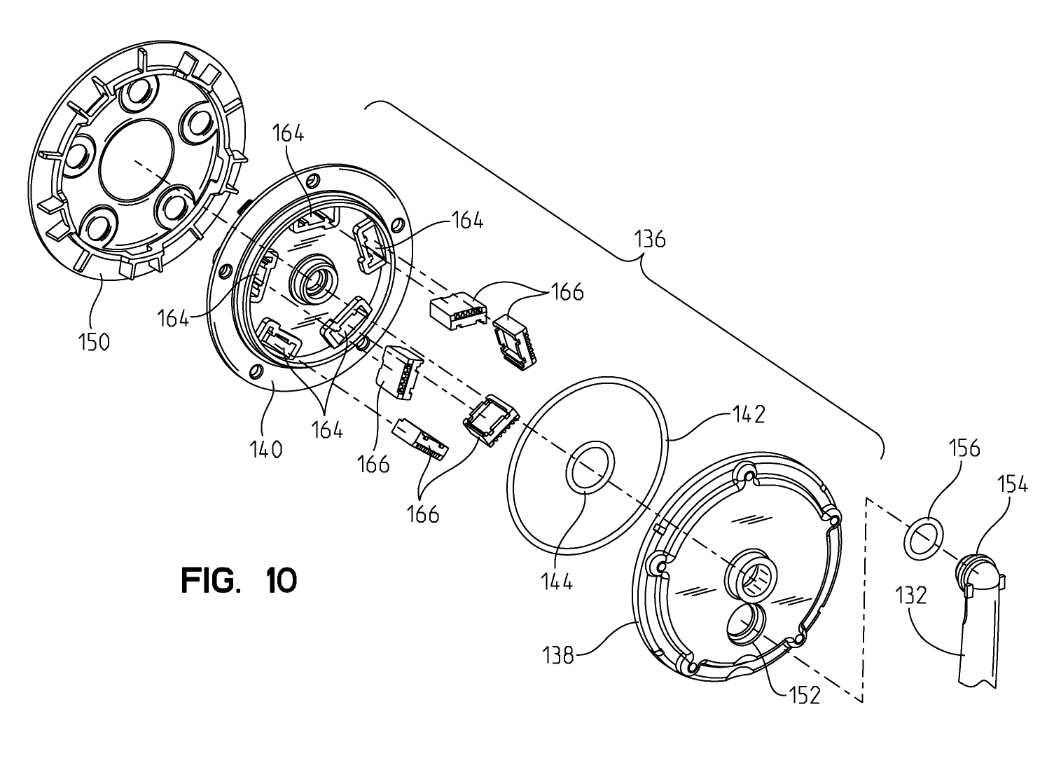

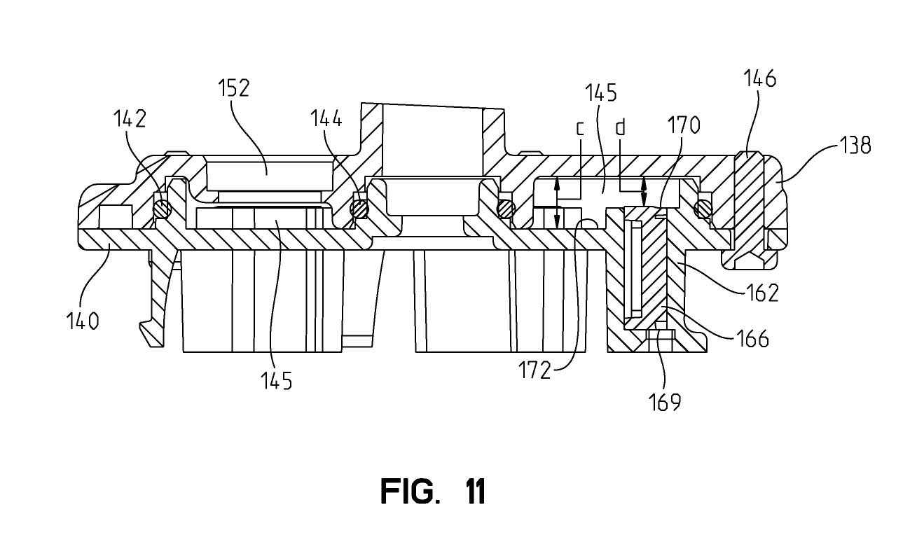

The handshower engine 136 illustratively includes a handshower engine waterway 138 coupled to a handshower engine spray face 140 (FIGS. 10 and 11). A pair of concentric o-rings 142 and 144 are illustratively positioned intermediate the waterway 138 and the spray face 140 to provide sealing engagement therebetween. A waterway chamber 145 is defined between the waterway 138 and the spray face 140. A plurality of screws 146 illustratively couple the spray face 140 to the waterway 138. In certain other embodiments, the waterway 138 and the spray face 140 may be coupled together through other means providing a seal therebetween, including through adhesives or hot plate welding, thereby eliminating the need for the screws 146 and o-rings 142 and 144.

A fastener, such as screw 148, may couple the handshower engine 136 to the shell 130. An outer cover or trim 150 is illustratively coupled to the spray head housing 108. The waterway 138 includes an opening 152 fluidly coupled to an outlet 154 of the waterway 132 and sealed therewith by an o-ring 156. A magnetically attractive member, such as a metal washer 158, is illustratively supported by a front surface 160 of the housing 108 and is configured to be attracted to the magnet 118 of the showerhead 12.

The spray face 140 includes a plurality of projections or bosses 162 defining chambers 164 to receive multi-dimensional fluid dispensers or fluidic devices 166. The trim 150 includes openings 168 aligned with outlets 169 of the fluidic devices 166 to accommodate water dispersed therefrom. Illustratively, the devices 166 are dimensioned to be press-fit into the chambers 164 of bosses 162. In a further illustrative embodiment, housings (not shown) may support the fluidic devices 166 within the bosses 162.

With reference to FIG. 11, the waterway chamber 145 defined between the waterway 138 and the spray face 140, as with the water chamber 63 of the showerhead 12, is configured to effectively minimize the volume of the chamber 145 in order to provide for improved responsiveness of the fluidic devices 166 upon water flow activation (i.e., “quick on” of all fluidic devices 166). Illustratively, the fluidic devices 166 are supported substantially outwardly from the spray face 140, such that the inlets 170 of the fluidic devices 166 are substantially level with an inwardly facing surface 172 of the spray face 140 (i.e., substantially within the same plane). While in FIG. 11 the inlets 170 are offset inwardly from surface 172 of the spray face 140 due to the sealing configuration of the o-rings 142 and 144, it should be noted that in configurations eliminating the o-rings 142 and 144, the inlets 170 and surface 172 may be substantially flush. The bosses 162 extend forwardly from the surface 172 to provide a substantially constant cross-sectional flow area within the waterway chamber 145. In other words, large changes in volume of the water chamber 145 from the inlet to the fluidic devices 166 are eliminated. With further reference to FIG. 11, the dimension “c” between waterway 138 and surface 172 is approximately 0.2 inches, while dimension “d” between waterway 138 and inlet 170 of fluidic device 166 is approximately 0.120 inches in order to provide proper water flow to, and operation of the fluidic devices 166 while facilitating quick responsiveness thereof.

As noted above, the base showerhead 12 and the removable handshower 14 include multi-dimensional fluidic devices 92 and 166, respectively, for providing for multi-dimensional spray patterns. Illustratively, the fluidic devices 92 and 166 are low-pressure, feedback passage-free fluidic oscillators which provide patternization, spray distribution across a fan angle, shape, and/or articulate a water spray. Illustratively, the fluidic devices 92 and 166 may be of the type manufactured by Bowles Fluidics Corporation of Columbia, Md., USA.

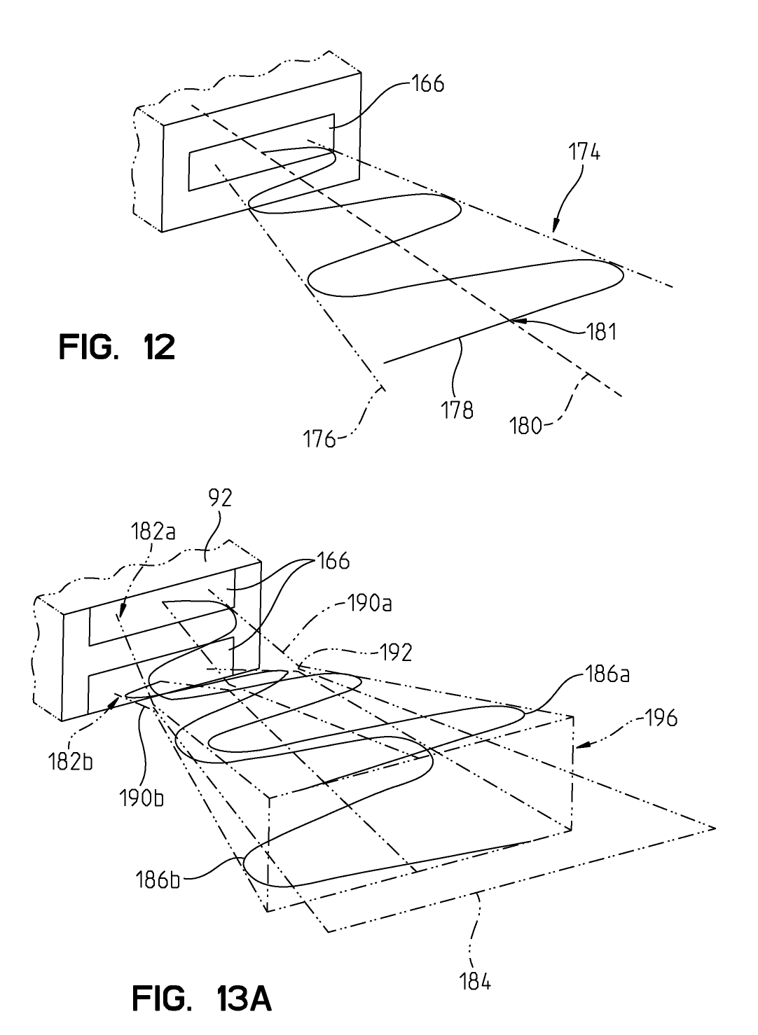

With reference to FIG. 12, the fluidic devices 166 are illustratively two-dimensional (2D) fluidic devices or nozzles that are configured to produce a fan of water 174 within a plane 176 by oscillating a water stream 178 about a center axis 180. The resulting spray 181 is illustratively a line in cross-section. A representative 2D fluidic device 166 includes the illustrative characteristics detailed in the following table.

2D Fluidic Device

| | |
|---|---|
| Nozzle Pressure (min.), psi | 3.5 |
| Cᵥ | 0.1095 |
| Nozzle Flow at 4.0 psi, gpm | 0.219 |
| Nozzle Flow at 3.5 psi, gpm | 0.205 |
| Nozzle Flow at 3.0 psi, gpm | 0.190 |
| Nozzle Flow at 2.5 psi, gpm | 0.173 |
| Nozzle Flow at 2.0 psi, gpm | 0.155 |
| Nozzle Flow at 1.5 psi, gpm | 0.134 |
| Nozzle Flow at 1.0 psi, gpm | 0.110 |
| Fan Angle, degrees | 18 +/− 3 |
| Nozzle Area, in² | 0.0044 |
| Nozzle Area Equiv. Dia., in | 0.0749 |

Minimum nozzle pressure is the recommended minimum water pressure for proper operation (i.e., oscillating water stream 178) of the fluidic device 166. Nozzle flow at various pressures is defined by the equation, Q=Cᵥ\sqrt{ΔP}, where Q is the flow rate through the nozzle, Cᵥ is the coefficient of velocity of the nozzle, and ΔP is the pressure change across the nozzle. For example, nozzle flow at a water pressure of 4 pounds per square inch (psi) is determined to be 0.219 gallons per minute (gpm) by the following calculation: 0.1095\sqrt{4}.

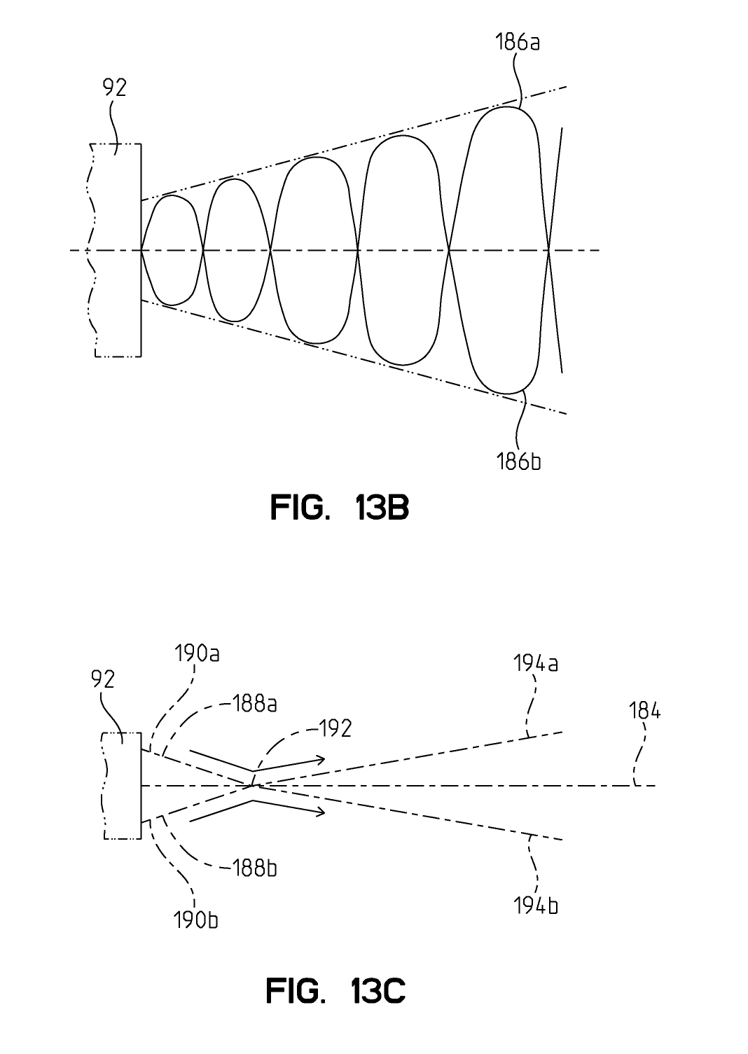

With reference to FIGS. 13A-13C, the fluidic devices 92 are illustratively three-dimensional (3D) fluidic devices or nozzles configured to produce a pair of interacting fans of water 182a, 182b. In general, each 3D fluidic device 92 comprises a pair of adjacent 2D fluidic devices 166 disposed parallel to each other. Moreover, the 3D effect may be produced by combining two 2D fluidic devices 166 that have initially converging fans of water 182a, 182b that upon contact proximate a center plane 184 reflect outwardly away from each other. Illustratively, the fans of water 182a, 182b are formed by oscillating water streams 186a, 186b about a respective center axis 188a, 188b within initially converging planes 190a, 190b. At convergence point 192, the fans of water 182a, 182b reflect away from each other in diverging planes 194a, 194b, thereby moving in a direction away from center plane 184. The resulting spray 196 illustratively defines a rectangular cross-section.

A representative 3D fluidic device 92 includes the illustrative characteristics detailed in the following table.

3D Fluidic Device

| | |
|---|---|
| Nozzle Pressure (min.), psi | 3.5 |
| Cᵥ | 0.1455 |
| Nozzle Flow at 4.0 psi, gpm | 0.291 |
| Nozzle Flow at 3.5 psi, gpm | 0.272 |
| Nozzle Flow at 3.0 psi, gpm | 0.252 |
| Nozzle Flow at 2.5 psi, gpm | 0.230 |
| Nozzle Flow at 2.0 psi, gpm | 0.206 |
| Nozzle Flow at 1.5 psi, gpm | 0.178 |
| Nozzle Flow at 1.0 psi, gpm | 0.146 |
| Fan Angle X, degrees | 32 +/− 5 |
| Fan Angle Z, degrees | 16 +/− 2 |
| Nozzle Area, in² | 0.0069 |
| Nozzle Area Equiv. Dia., in | 0.0937 |

Minimum nozzle pressure is the recommended minimum water pressure for proper operation (i.e., oscillating water streams 186a, 186b) of the fluidic device 92. Nozzle flow at various pressures is defined by the equation, Q=Cᵥ\sqrt{ΔP}, where Q is the flow rate through the nozzle, Cᵥ is the coefficient of velocity of the nozzle, and ΔP is the pressure change across the nozzle. For example, nozzle flow at a water pressure of 4 pounds per square inch (psi) is determined to be 0.291 gallons per minute (gpm) by the following calculation: 0.1455\sqrt{4}.

The number (including the ratio of 2D fluidic devices 166 to 3D fluidic devices 92), placement, and relative orientations of the fluidic devices 92 and 166 may vary depending upon the flow rate of water (as limited by flow restrictor 75), the operating pressure of the fluidic device, the desired task, and user preferences. In the illustrative embodiment shown in FIG. 5, five (5) 2D fluidic devices 166 are supported within the handshower 14, while six (6) fluidic devices 92 are supported within the base showerhead 12. This number of fluidic devices 166, 92 provides adequate sprays 181 and 196 with flow rates at the inlet as low as 2.0 gpm. The 2D fluidic devices 166 within the handshower 14 provide a forceful spray 181 for cleaning tasks, while the 3D fluidic devices 92 within the base showerhead 12 provide a more gentle or soaking spray 196. Combined operation of the 2D fluidic devices 166 and the 3D fluidic devices 92 provide a spray of intermediate force. While the fluidic devices 166 and 92 are oriented to provide sprays 196, 181 with a primary or major dimension extending tangent to a radius extending from the center of the respective handshower 14 and showerhead 12 (FIG. 5), other orientations may be desired based upon user preferences (for example, the size of the bathing area relative to the spray 196, 181).

Required flow rates to achieve certain water pressures across representative combinations of fluidic devices 92, 166 may be calculated based upon the above detailed fluidic device characteristics. As detailed herein, for the illustrated embodiment removable handshower 14, five (5) 2D fluidic devices 166 are provided. Based upon the characteristics of the fluidic devices 166, at 3.5 psi, a flow rate of 1.025 gpm (5×0.205 gpm) is required. Similarly, for the illustrative embodiment base showerhead 12, six (6) 3D fluidic devices 92 are provided. Based upon the characteristics of the fluidic devices 92, at 3.5 psi, a flow rate of 1.632 gpm (6×0.272 gpm) is required.

Similar calculations may be used to determine required flow rates for hybrid engines (combinations of 2D and 3D fluidic devices 166, 92 in a single handshower 14 or base showerhead 12). For example, six (6) 2D fluidic devices 166 at 3.5 psi requires a flow rate of 1.23 gpm (6×0.205 gpm), while five (5) 3D fluidic devices 92 at 3.5 psi requires a flow rate of 1.36 gpm (5×0.272 gpm). The total required flow rate is therefore 2.59 gpm (1.23 gpm for the 2D fluidic devices 166, plus 1.36 gpm for the 3D fluidic devices 92).

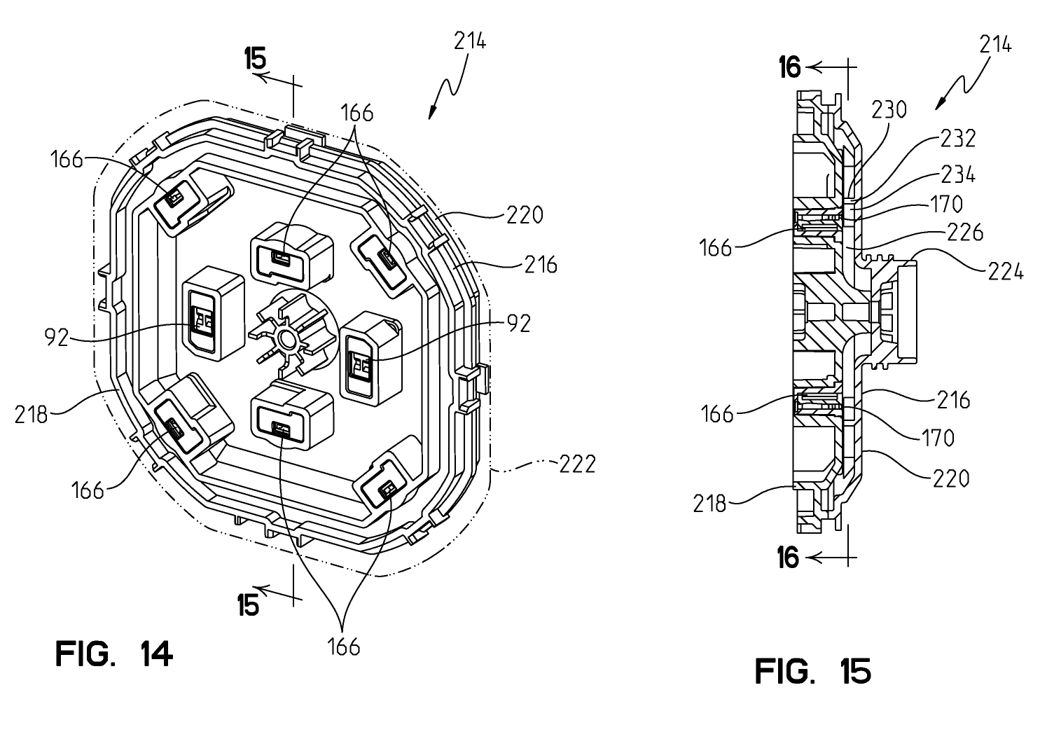

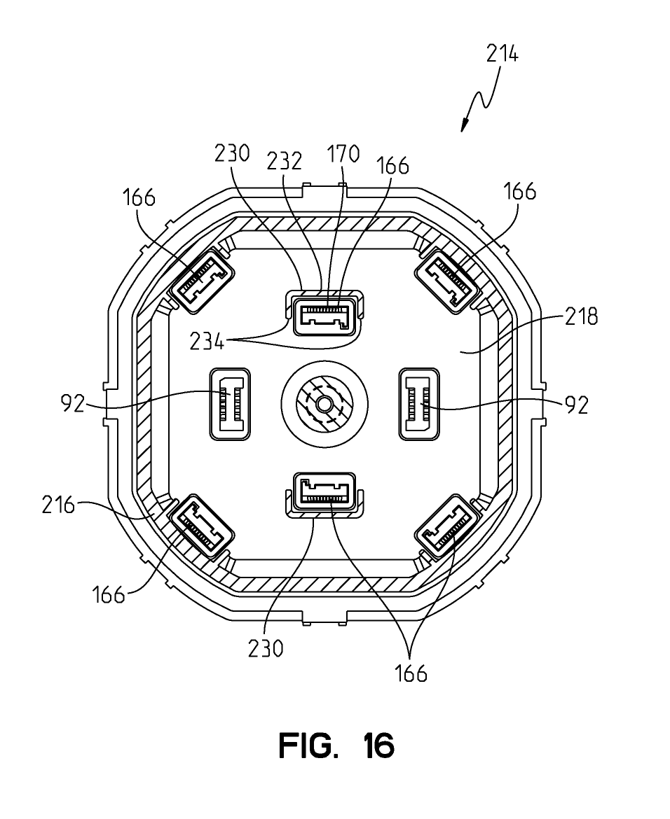

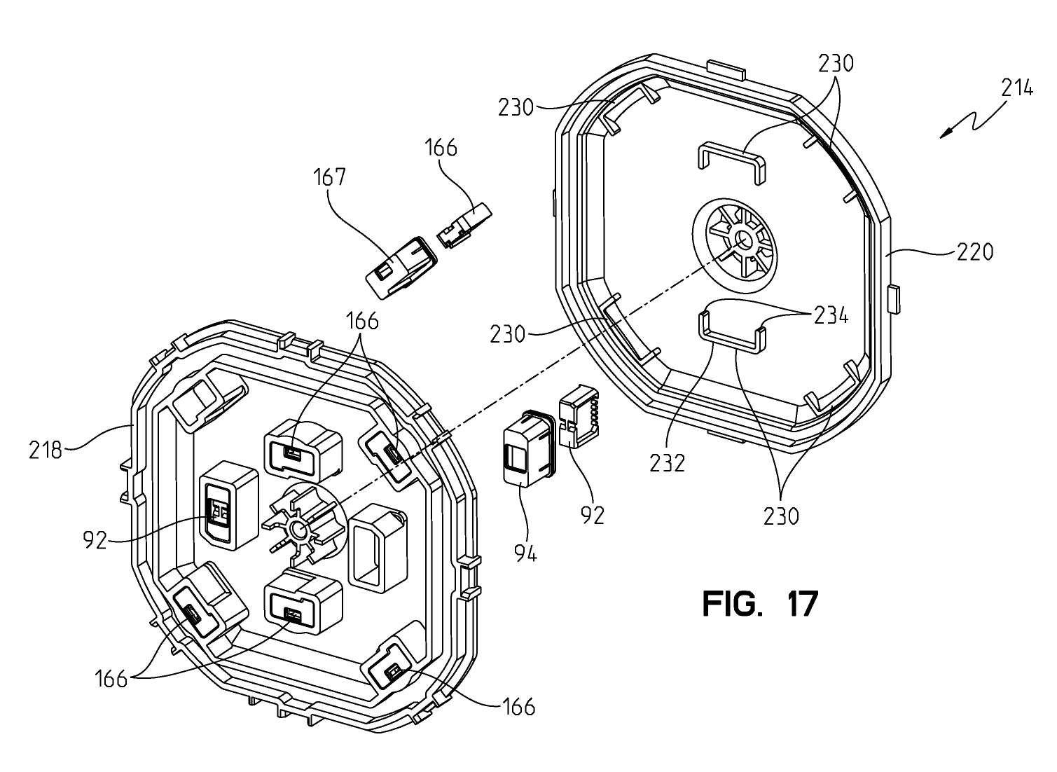

Referring now to FIGS. 14-17, a further illustrative showerhead 214 is shown as including a housing 216 formed by a front shell 218 coupled to a rear shell 220, illustratively through conventional means such as hot plate welding or adhesives. Trim, illustratively a faceplate or outer cover 222 may be coupled to the front shell 218. The rear shell 220 illustratively defines an inlet 224 fluidly coupled to a water supply. A waterway 226 is defined intermediate the front shell 218 and the rear shell 220 and is fluidly coupled to the inlet 224.

A plurality of fluidic devices 92, 166 are supported by the front shell 218 and are in fluid communication with the waterway 226. Illustratively, two (2) 3D fluidic devices 92 and six (6) 2D fluidic devices 166 are supported by the front shell 218. Each 3D fluidic device 92 is illustratively received within a housing 94, while each 2D fluidic device 166 is illustratively received within a housing 167.

In order to prevent water within the waterway 226 from jetting or skipping over the inlets 170 to the 2D fluidic devices 166, a shield 230 is supported by the rear shell 216. Each shield 230 includes a rear wall 232 and a pair of side walls 234 extending within the waterway 226 partially around three sides of the respective 2D fluidic device 166. As may be appreciated, the shield 230 assists in directing water to the inlet 170 of the respective fluidic device 166.

With reference to FIGS. 18-20B, an illustrative docking or coupling arrangement between sprayhead 12′ and base showerhead 14′ is shown. The ring 104′ defines a docking collar 250 configured to removably receive the neck 252 of the handle 114′ of sprayhead 12′. More particularly, the docking collar 250 includes a front surface 254 and opposing side surfaces 256 tapered inwardly and downwardly for cooperating with the contour of the outer surface 258 of neck 252.

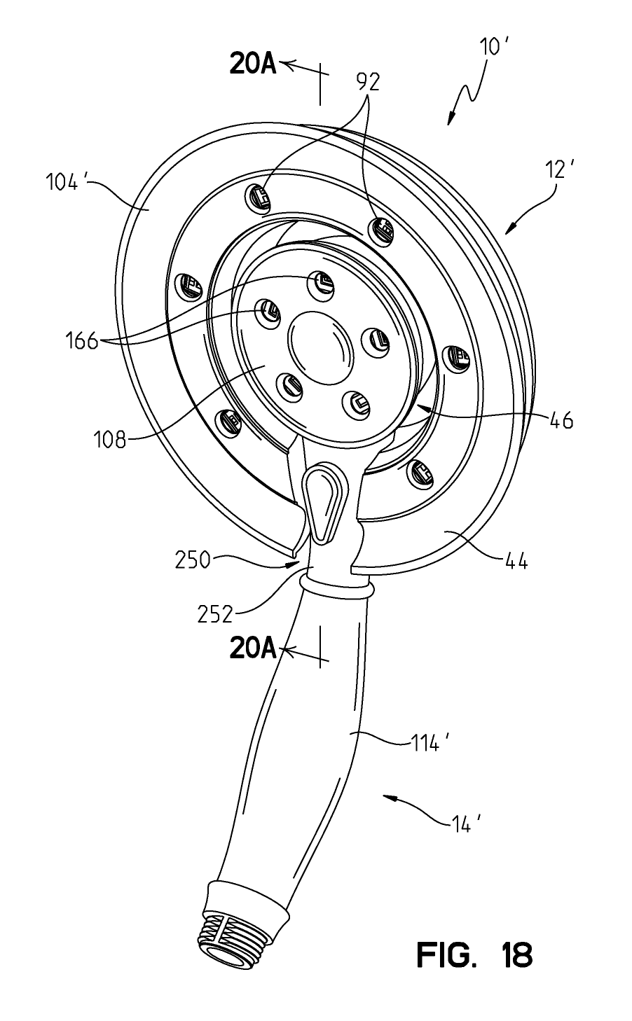

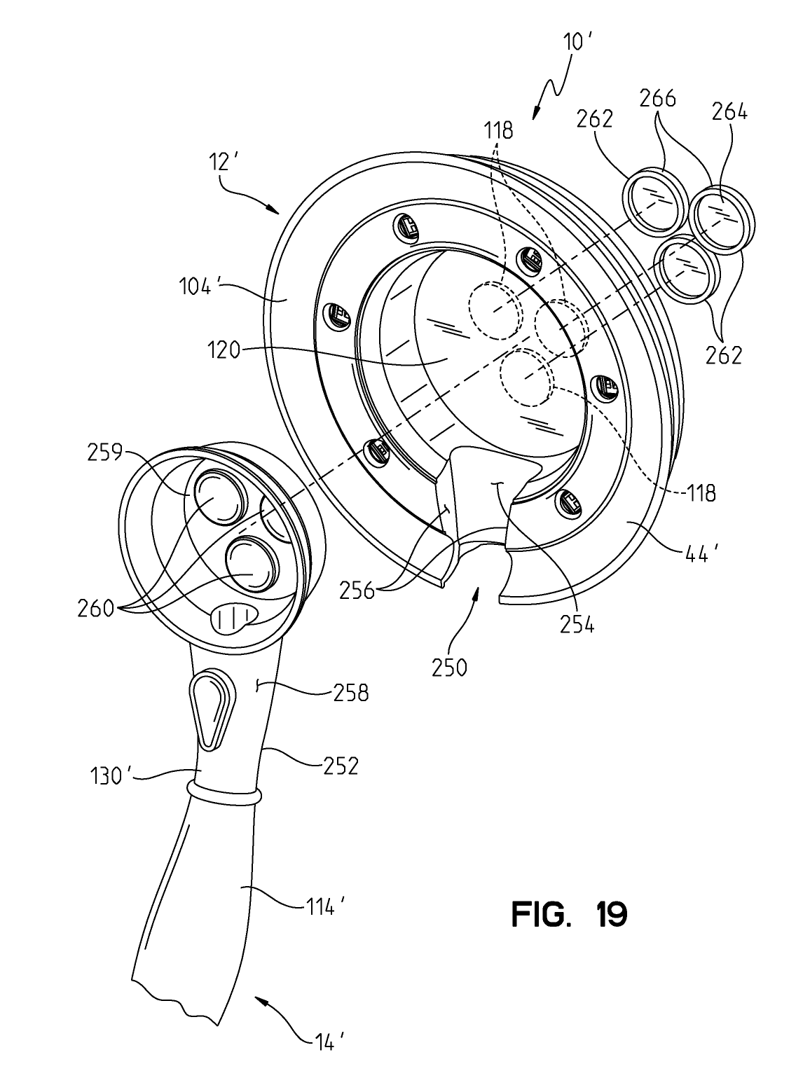

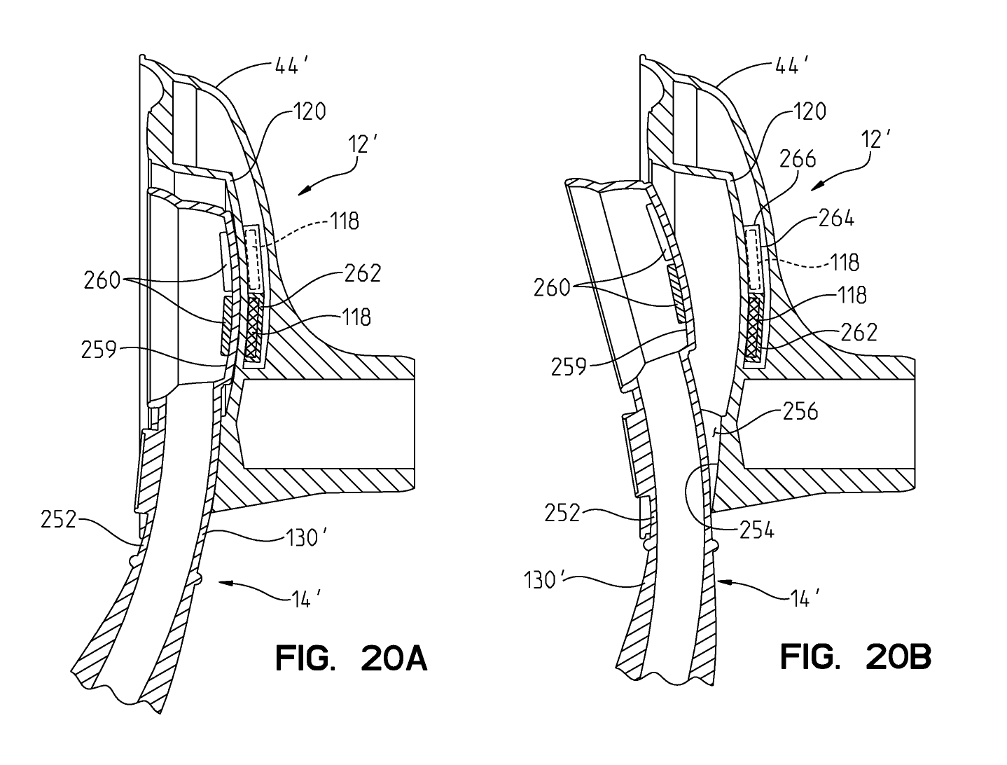

A plurality of magnets 118 are illustratively supported by rear wall 120 of the showerhead 14′ and are configured to releasably secure the handshower 14′ to the base showerhead 12′. More particularly, the magnets 118 magnetically couple with magnetically attractive members 260 supported by a rear wall 259 of shell 130′. FIG. 20A shows the handshower 14′ fully docked with the showerhead 12′, wherein the neck 252 of the handshower 14′ is received within the docking collar 250 of the sprayhead 12′, and the magnetically attractive members 260 of the handshower 14′ are magnetically coupled to the magnets 118 of the sprayhead 12′. FIG. 20B shows the handshower 14′ partially uncoupled from the sprayhead 12′, wherein the handle 114′ of the handshower 14′ is moved upwardly and outwardly relative to the docking collar 250, and the magnetically attractive members 260 of the handshower 14′ are pulled away from the magnets 118 of the sprayhead 12′.

The magnets 118 may comprise any conventional material generating magnetic fields, such as NdFeB, a permanent magnet material typically referred to as neodymium or neo. The magnetically attractive members 260 may comprise any material attracted to magnetic fields including other magnets and metals, such as steel discs or washers. In order to protect against corrosion due to moisture, both the magnets 118 and the magnetically attractive members 260 may include a protective coating or plating. In another embodiment, housing 44′ may be partially or fully overmolded about magnets 118, and shell 130′ may be partially or fully overmolded about magnetically attractive members 260. Overmolding is configured to protect the connecting elements 118 and 260 from corrosion due to contact with fluids including water.

While FIG. 19 shows three magnets 118 arranged in a triangular configuration, any suitable number and/or configuration of magnets 118 may be substituted therefore. For example, a single magnet 118 may be provided on the showerhead 12′ and a single cooperating attractive member 260 may be provided on the handshower 14′. In an alternative embodiment, a pair of magnets 118 may be vertically aligned on the showerhead 12′ and a pair of cooperating attractive members 260 may be vertically aligned on the handshower 14′. In the illustrative embodiments, at least one magnet 118 is positioned in a lower portion of the rear wall 120 of the showerhead 12′ to oppose pull forces applied to the handshower 14′ by reducing the resulting moment arm applied to handle 114.

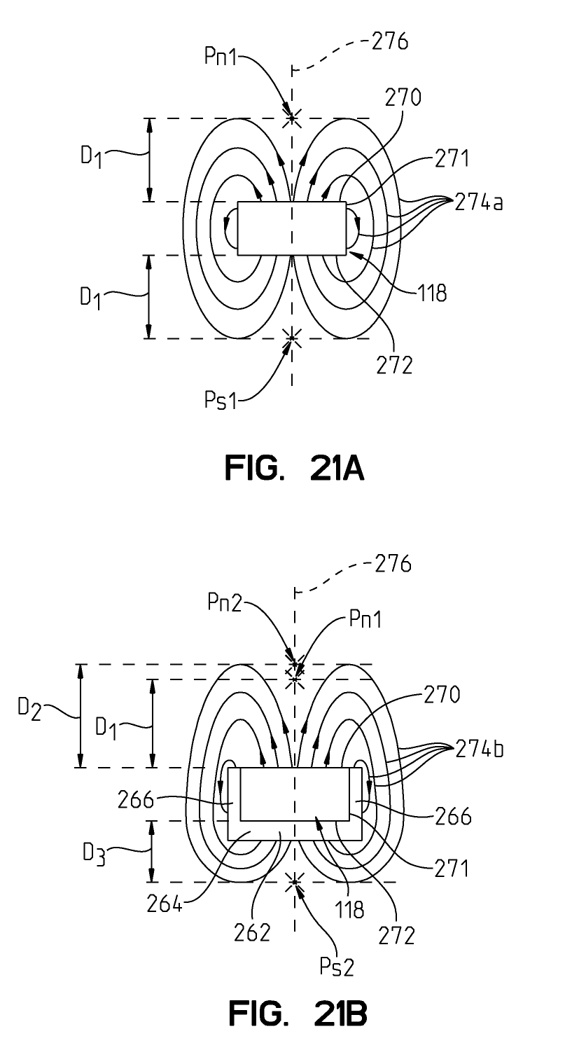

With reference to FIGS. 19-21B, each magnet 118 may be operably coupled to a backing element 262. Illustratively, the backing element 262 comprises a cup including a base disc 264 and cylindrical sidewall 266. The backing element 262 may increase the attractive force of a magnetic coupling. Referring now to FIGS. 21A and 21B, the magnetic flux densities of two magnetic fields are schematically represented by magnetic flux lines 274a and 274b. FIG. 21A shows representative magnet 118 having magnetic flux lines 274a that extend from surfaces 270, 271, 272 connecting its north and south poles. Spaced-apart surfaces 270, 272 define the thickness of magnet 118. At points P_{N1} and P_{S1} located at a distance D₁ perpendicularly away from surfaces 270 and 272, respectively, on centerline 276, the magnetic field equals F gauss.

FIG. 21B shows magnet 118 coupled to backing element 262, and having flux lines 274b that extend from surface 270, 271 to and through backing element 262 to surfaces 271, 272 connecting its north and south poles. At points P_{N2} and P_{S2} located at corresponding distances D₂ and D₃ perpendicularly away from surfaces 270 and 272, respectively, on centerline 276, the magnetic field also has a value equal to F gauss. D₂ is greater than both D₁ and D₃ meaning that the magnetic field strength changed as a result of the addition of backing element 262, and that backing element 262 increased the strength of the magnetic field at point P_{N1} a distance D₁ perpendicularly away from surface 270. A suitable backing element 262 may be comprised of steel, iron, and other non-magnetic magnetically attractive materials. Depending on the selection of materials and particular designs, the magnetic flux density at a distance away from the surface of magnet 118 may be increased more by the addition of backing element 262 than by an increase in the thickness of magnet 118 equal to the thickness of backing element 262. Thus, a stronger attractive force may be achieved with a smaller, less costly, corrosion resistant connector.

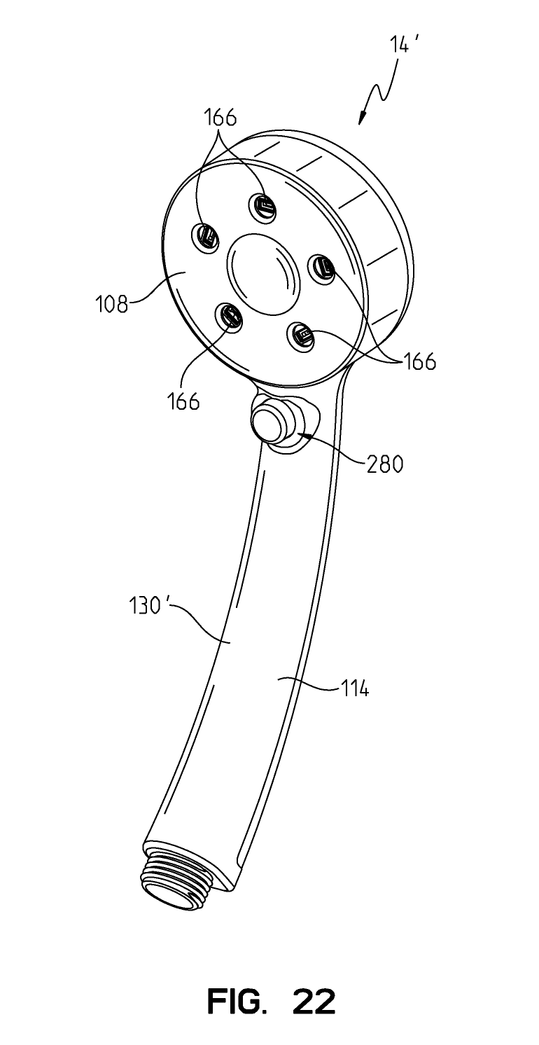

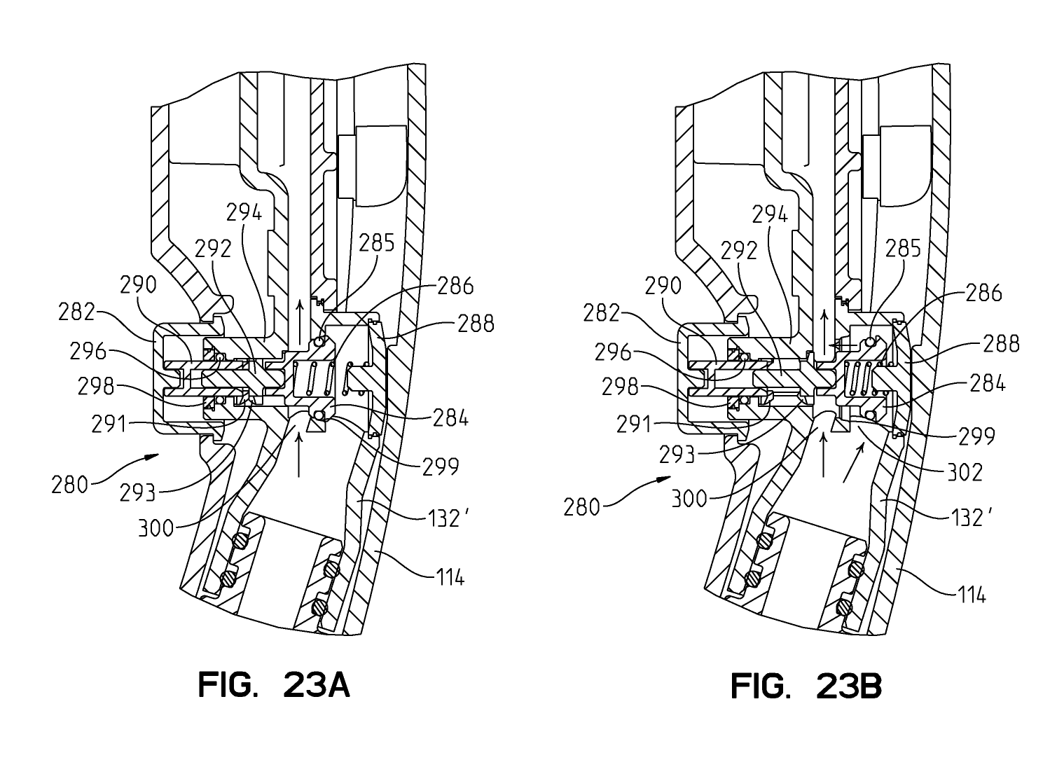

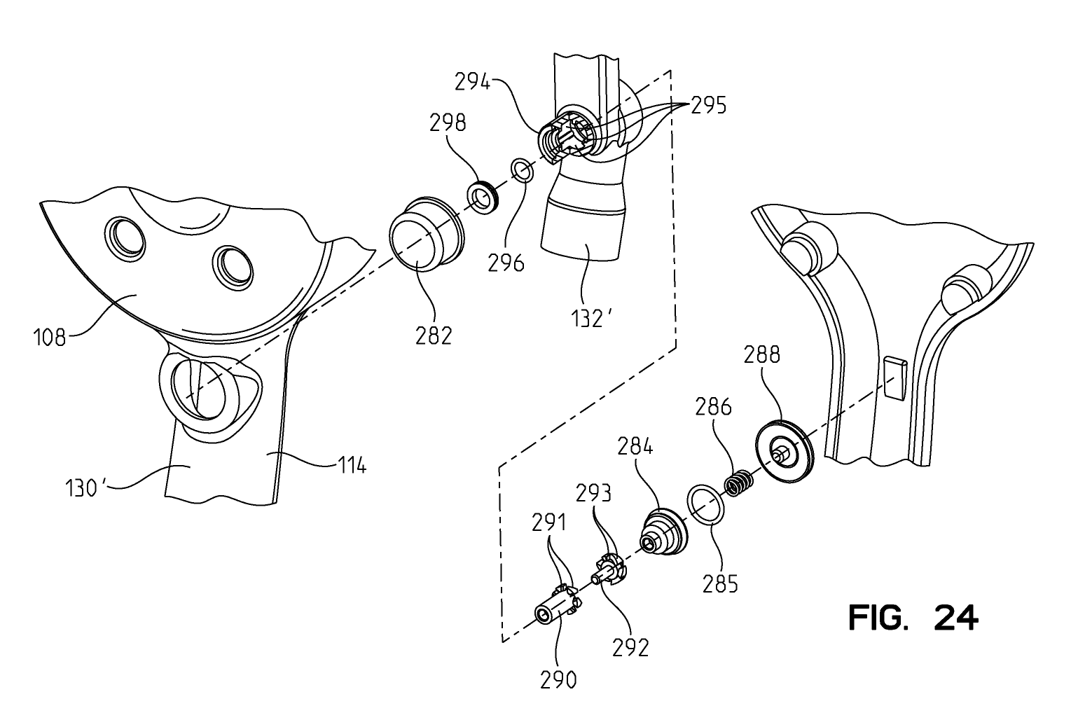

With reference now to FIGS. 22-24, illustrative handshower 14′ is shown as including a flow control valve 280 supported by the handle 114. The flow control valve 280 illustratively provides for two discrete flow rates, including a low flow rate as shown in FIG. 23A and a high flow rate as shown in FIG. 23B. Different flow rates may be preferred by different users and for different tasks, particularly given the performance characteristics of the 2D fluidic devices 166. For example, some users may find more comfortable a lesser flow velocity through the 2D fluidic devices 166. The flow control valve 280 illustratively includes a two-position clicker or toggle mechanism to alternate between the low flow rate position and the high flow rate position of FIGS. 23A and 23B, respectively. In alternative embodiments, flow control valve 280 may provide for continuous adjustment of flow rate between a low flow mode and a high flow mode.

The flow control valve 280 includes a push button cover 282 that may be depressed by a user holding the handle 114. A switch core or shuttle 284 is received within the waterway 132′ and supports a seal, illustratively an o-ring 285. A spring 286 is supported by a flow cap 288 and biases the shuttle 284 (e.g., toward the left in FIGS. 23A and 23B). The flow cap 288 seals the waterway 132′. A toggle or clicker assembly includes a button mandrel 290 and a button core or flange 292 received within a hub 294, illustratively defined by the waterway 132′. More particularly, the button mandrel 290 includes angled teeth 291 configured to cooperate with angled teeth 293 of the button core 292. The hub 294 includes a plurality of grooves or slots 295 configured to received the teeth 291 and 293. An o-ring 296 may be secured in place by a retainer 298 received within hub 294. Cover 282 is configured to engage an end of the button mandrel 290, thereby causing button core 292 to move the shuttle 284 against the bias of the spring 286 and changing the resulting flow rate through the waterway 132′.

As noted above, FIG. 23A illustrates a low flow rate operating mode where the o-ring 285 of the shuttle 284 sealingly engages a valve seat 299 defined by an inner surface of the waterway 132′. As such, water flows through a single passageway 300 toward the fluidic devices 166 of sprayhead housing 108. Upon depressing the button cover 282, the button mandrel 290 is moved to the right as shown in FIG. 23B. At the same time, the angled teeth 291 of the button mandrel 290 engage the angled teeth 293 of the button core 292, thereby forcing the button core 292 to the right. The teeth 293 are pushed out of the slots 295 of the hub 294, such that teeth 291 cause the button core 292 to rotate counterclockwise. Upon rotating counterclockwise, since the teeth 293 of the button core 292 are no longer received within the slots 295 of the hub 294, the button core 292 is retained in the retracted position of FIG. 23B against the force of the spring 286. Movement of the button core 292 to the right also causes movement of the shuttle 284 to the right, such that the o-ring 285 is displaced from the valve seat 299. As such, a second flow path 302 is provided in combination with the first flow path 300 to provide increased flow rate to the fluidic devices 166 of the showerhead 108.

When in the high flow mode position of FIG. 23B, depressing the button cover 282 will cause the button mandrel 290 to move further to the right, thereby causing the angled teeth 291 of the button mandrel 290 to engage the angled teeth 293 of the button core 292. As a result, the button core 292 is again rotated counterclockwise such that the teeth 293 of the button core 292 are aligned with the slots 295 of the hub 294. The spring 286 then biases the shuttle 284 and the button core 292 to the left and to the home or low flow position of FIG. 23A. In the low flow mode, the o-ring 285 seals against the valve seat 299, thereby closing water pathway 302 and limiting water flow through water pathway 300.

FIG. 25 shows a further illustrative showerhead assembly 310 including a base showerhead 312 and a removable handshower 314. The showerhead 312 illustratively includes vertically extending housing members 316a, 316b spaced on opposing sides of a receiving recess 318 for releasably supporting the handshower 314. Illustratively, each housing member supports three fluidic devices 92. The handshower 314 includes an outlet housing 320 supporting four fluidic devices 92. Each of the fluidic devices 92 are illustratively of the three-dimensional configuration detailed above, and are oriented both in the showerhead 312 and the handshower 314 to provide for streams oscillating in planes diverging from a center horizontal plane. It should be appreciated that the numbers and types of fluidic devices (e.g., 2D fluidic devices 166 vs. 3D fluidic devices 92) may vary.

FIG. 26 shows another illustrative showerhead assembly 410 including a base showerhead 412 and a removable handshower 414. The showerhead 412 illustratively includes vertically extending housing members 416a, 416b spaced on opposing sides of a receiving recess 418 for releasably supporting the handshower 414. Illustratively, each housing member 416 supports two fluidic devices 92. The handshower 414 includes an outlet housing 420 supporting three fluidic devices 92. Each of the fluidic devices 92 are illustratively of the three-dimensional configuration detailed above. The fluidic devices 92 of the showerhead 412 are oriented to provide for streams oscillating in planes diverging from a center vertical plane, while the fluidic devices 92 of the handshower 414 are oriented perpendicular to the fluidic devices 92 to provide for streams oscillating in planes diverging from a center horizontal plane. It should be appreciated that the numbers and types of fluidic devices (e.g., 2D fluidic devices 166 vs. 3D fluidic devices 92) may vary.

FIG. 27 shows a further illustrative showerhead assembly 510 including a base showerhead 512 and a removable handshower 514. The showerhead 512 illustratively includes a vertically extending housing member 516 spaced on a side of a receiving recess 518 for releasably supporting the handshower 514. Illustratively, the showerhead 512 and the handshower 514 each include four fluidic devices 92. The fluidic devices 92 are illustratively of the three-dimensional configuration detailed above. It should be appreciated that the numbers and types of fluidic devices (e.g., 2D fluidic devices 166 vs. 3D fluidic devices 92) may vary.

FIG. 28 shows a further illustrative showerhead assembly 610 including a base showerhead 612 and a removable handshower 614. The showerhead 612 illustratively includes a horizontally extending housing member 616 spaced above a receiving recess 618 for releasably supporting the handshower 614. Illustratively, the showerhead 612 and the handshower 614 each include four fluidic devices 92. The fluidic devices 92 are illustratively of the three-dimensional configuration detailed above. It should be appreciated that the numbers and types of fluidic devices (e.g., 2D fluidic devices 166 vs. 3D fluidic devices 92) may vary.

Although the invention has been described in detail with reference to certain preferred embodiments, variations and modifications exist within the spirit and scope of the invention as described and defined in the following claims.

1. A showerhead assembly comprising:
a base showerhead;
a handshower removably coupled to the base showerhead;
a plurality of two dimensional fluidic devices supported by the handshower and configured to produce a fan of water within a plane by oscillating water about a center axis; and
a plurality of three dimensional fluidic devices supported by the base showerhead and configured to produce a plurality of fans of water within diverging planes, the water oscillating within each of the planes about a center axis.

2. The showerhead assembly of claim 1, further comprising a magnet supported by one of the base showerhead and the handshower, and a magnetically attractive member supported by the other one of the handshower and the base showerhead, wherein the magnet attracts the magnetically attractive member to hold the handshower relative to the base showerhead.

3. The showerhead assembly of claim 2, further comprising a backing element operably coupled to the magnet to reorient the magnetic field from the magnet.

4. The showerhead assembly of claim 3, wherein the backing element comprises a cup including a base disc and a cylindrical sidewall.

5. The showerhead assembly of claim 1, further comprising a diverter valve supported by the base showerhead and configured to control water flow from an inlet to one of the two dimensional fluidic devices of the handshower, the three dimensional fluidic devices of the base showerhead, and both the two dimensional fluidic devices and the three dimensional fluidic devices.

6. The showerhead assembly of claim 1, further comprising an inlet supported by the base showerhead and configured to be fluidly coupled to a water supply, and a flow restrictor supported by the base showerhead and configured to limit the flow rate of water through the inlet to no greater than 2.5 gallons per minute.

7. The showerhead assembly of claim 1, wherein the handshower further includes a flow control valve configured to control the flow rate of water delivered to the two dimensional fluidic devices supported by the handshower.

8. The showerhead assembly of claim 7, wherein the flow control valve includes discrete low flow and high flow positions.

9. The showerhead assembly of claim 1, further comprising a plurality of water shields extending at least partially around three sides of the two dimensional fluidic devices to direct water toward the inlets of the two dimensional fluidic devices.

10. The showerhead assembly of claim 1, wherein the base showerhead includes an arcuate housing defining a center opening for receiving a sprayhead housing of the handshower.

11. The showerhead assembly of claim 10, wherein the arcuate housing of the base showerhead includes a tapered docking collar, and the handshower includes a handle coupled to the sprayhead housing and including a neck configured to be releasably received within the tapered docking collar.

12. A showerhead assembly comprising:
a first fluid dispensing unit including a plurality of first fluidic devices;
a second fluid dispensing unit removably coupled to the first fluid dispensing unit and including a plurality of second fluidic devices; and
wherein the first fluidic devices and the second fluidic devices each provide a multi-dimensional spray pattern.

13. The showerhead assembly of claim 12, wherein the first fluid dispensing unit comprises a base showerhead, and the second fluid dispensing unit comprises a handshower.

14. The showerhead assembly of claim 13, wherein:
the first fluidic devices comprise two dimensional fluidic devices supported by the handshower and configured to produce a fan of water within a plane by oscillating water about a center axis; and
the second fluidic devices comprise three dimensional fluidic devices supported by the base showerhead and configured to produce a plurality of fans of water within diverging planes, the water oscillating within each of the planes about a center axis.

15. The showerhead assembly of claim 14, further comprising a magnet supported by one of the base showerhead and the handshower, and a magnetically attractive member supported by the other one of the handshower and the base showerhead, wherein the magnet attracts the magnetically attractive member to hold the handshower relative to the base showerhead.

16. The showerhead assembly of claim 15, further comprising a backing element operably coupled to the magnet to reorient the magnetic field from the magnet.

17. The showerhead assembly of claim 16, wherein the backing element comprises a cup including a base disc and a cylindrical sidewall.

18. The showerhead assembly of claim 14, further comprising a diverter valve supported by the base showerhead and configured to control water flow from an inlet to one of the two dimensional fluidic devices of the handshower, the three dimensional fluidic devices of the base showerhead, and both the two dimensional fluidic devices and the three dimensional fluidic devices.

19. The showerhead assembly of claim 14, wherein the handshower further includes a flow control valve configured to control flow rate of water delivered to the two dimensional fluidic devices supported by the handshower.

20. The showerhead assembly of claim 19, wherein the flow control valve includes discrete low flow and high flow positions.

21. The showerhead assembly of claim 14, further comprising a plurality of water shields extending at least partially around three sides of the two dimensional fluidic devices to direct water toward the inlets of the two dimensional fluidic devices.

22. The showerhead assembly of claim 13, wherein the base showerhead includes an arcuate housing defining a center opening for receiving a sprayhead housing of the handshower.

23. The showerhead assembly of claim 22, wherein the arcuate housing of the base showerhead includes a tapered docking collar, and the handshower includes a handle coupled to the sprayhead housing and including a neck configured to be releasably received within the tapered docking collar.

24. A showerhead assembly comprising:
a base;
a handshower removably coupled to the base;
a plurality of two dimensional fluidic devices supported by the handshower and configured to produce a fan of water within a plane by oscillating water about a center axis; and
a flow control valve configured to control the flow rate of water delivered to the two dimensional fluidic devices supported by the handshower.

25. The showerhead assembly of claim 24, wherein the base comprises a fixed showerhead, and a plurality of three dimensional fluidic devices are supported by the fixed showerhead and configured to produce a plurality of fans of water within diverging planes, the water oscillating within each of the planes about a center axis.

26. The showerhead assembly of claim 24, wherein the flow control valve includes discrete low flow and high flow positions.

27. The showerhead assembly of claim 26, wherein the flow control valve includes a button, a shuttle operably coupled to the button, a seal supported by the shuttle, and a toggle assembly configured to be in the high flow position when the button is depressed a first time, and configured to be in the low flow position when the button is depressed a second time.

28. The showerhead assembly of claim 24, wherein the handshower includes a waterway in fluid communication with inlets of the two dimensional fluidic devices, and a plurality of water shields extending at least partially around three sides of the two dimensional fluidic devices to direct water toward the inlets of the two dimensional fluidic devices.

29. The showerhead assembly of claim 24, further comprising:
a magnet, and a magnetically attractive member, wherein the magnet attracts the magnetically attractive member to hold the handshower relative to the base; and
a backing element operably coupled to the magnet to reorient the magnetic field from the magnet.

30. The showerhead assembly of claim 29, wherein the backing element comprises a cup including a base disc and a cylindrical sidewall.
